(19) United States
(12) Patent Application Publication
(10) Pub. No.: US 2026/0328298 A1
(43) Pub. Date: Oct. 22, 2026

(54) MULTIFUNCTIONAL VALVE DEDICATED FOR HIGH-PRESSURE FUEL TANK OF HYBRID ELECTRIC VEHICLE

(71) Applicant: Daisheng Automotive Technology (Suzhou) Co., Ltd., Suzhou (CN)

(72) Inventor: Zhansheng ZHAO, Suzhou (CN)

(73) Assignee: Daisheng Automotive Technology (Suzhou) Co., Ltd., Suzhou (CN)

(21) Appl. No.: 19/630,350

(22) Filed: Mar. 26, 2026

Related U.S. Application Data
(63) Continuation of application No. PCT/CN2025/126439, filed on Oct. 9, 2025.

(30) Foreign Application Priority Data
Feb. 28, 2025 (CN) 202510233263.5

(51) Int. Cl. F16K 11/10; B60K 15/03; B60K 15/035; B60K 15/077; F16K 31/18

(52) U.S. Cl. CPC F16K 11/10; B60K 15/03504; B60K 15/077; F16K 31/18; B60K 2015/03289

(57) ABSTRACT

A multifunctional valve dedicated for a high-pressure fuel tank of a hybrid electric vehicle. The multifunctional valve includes an upper cover securely connected to a high-pressure fuel tank; a lower housing located inside the high-pressure fuel tank and has a first accommodating cavity and a second accommodating cavity; and a connecting member connected between the upper cover and the lower housing. The multifunctional valve also includes a fueling control valve assembly arranged in the first accommodating cavity of the lower housing and can float up and down within the first accommodating cavity; a gradient exhaust assembly arranged in the second accommodating cavity of the lower housing and can float up and down within the second accommodating cavity; and a refueling control valve assembly arranged on the connecting member above the gradient exhaust assembly.

### CROSS-REFERENCE TO RELATED APPLICATION

This patent application is a continuation application of International Patent Application No. PCT/CN 2025/126439, filed on Oct. 9, 2025, which claims priority of Chinese Patent Application No. 2025102332635, filed on Feb. 28, 2025, both of which are incorporated by references in their entirety.

### TECHNICAL FIELD

At least one embodiment of the invention relates to the technical field of high-pressure fuel tanks of hybrid electric vehicles, and in particular to a multifunctional valve dedicated for a high-pressure fuel tank of a hybrid electric vehicle.

### BACKGROUND

Currently, hybrid electric vehicles (including plug-in hybrid electric vehicles, non-plug-in hybrid electric vehicles, and extended-range hybrid electric vehicles) have developed rapidly, and are of the mainstream new energy vehicle models on the market. Compared to low-pressure fuel tanks used in conventional fuel vehicles, high-pressure fuel tanks used in the hybrid electric vehicles have higher requirements in terms of pressure resistance, exhaust pressure, exhaust flow, pressure relief time, low noise, and so on.

Conventional control valves have the following defects:

(1) Conventional fueling control valves have limited functions, and multiple functions cannot be controlled by using one valve. Generally, multiple different control valves are arranged on the fuel tank; (2) when the conventional control valves control fueling, the experience feeling of drivers and passengers is affected due to the larger noise caused by floats' bumping; (3) the conventional control valves have a longer response time from high pressure relief to low pressure relief, and thus cannot meet the pressure relief requirements of the high-pressure fuel tanks. Therefore, there is an urgent need to provide a multifunctional valve dedicated for a high-pressure fuel tank of a hybrid electric vehicle, which can simultaneously achieve the above functions.

### SUMMARY

The technical problem to be solved by the present disclosure is: to provide a multifunctional valve dedicated for a high-pressure fuel tank of a hybrid electric vehicle, in order to overcome the shortcomings of the conventional art.

The technical solution adopted by the present disclosure to solve the technical problem thereof will be described as below: A multifunctional valve dedicated for a high-pressure fuel tank of a hybrid electric vehicle, including:
an upper cover securely connected to a high-pressure fuel tank, and is provided with a vent opening at a portion of the upper cover located on an outer side of the high-pressure fuel tank;
a lower housing located inside the high-pressure fuel tank and including a first accommodating cavity and a second accommodating cavity, a bottom of the second accommodating cavity being higher than a bottom of the first accommodating cavity;
a connecting member with an upper end connected to the upper cover and a lower end connected to the lower housing, the connecting member serving as an intermediate member to be connected between the upper cover and the lower housing;
a fueling control valve assembly arranged in the first accommodating cavity of the lower housing, and can float up and down within the first accommodating cavity to control a fueling amount;
where a shock-absorbing pad is arranged at the bottom of the first accommodating cavity, to avoid noise produced due to the bumping between the bottoms of floats of the fueling control valve assembly and the lower housing; the fueling control valve assembly controls the volume of fuel filled after automatic shut-off of the first time of fueling, to reach a rated volume of the fuel tank;
a gradient exhaust assembly arranged in the second accommodating cavity of the lower housing, and can float up and down within the second accommodating cavity to achieve exhaust; where the gradient exhaust assembly controls the exhausting performance of the high-pressure fuel tank at various angles of inclination; and
a refueling control valve assembly arranged on the connecting member above the gradient exhaust assembly, and is configured to control an amount of supplemented fuel during refueling; where the refueling control valve assembly controls a volume of fuel continuing to be supplemented at a time after the automatic shut-off of the first time of fueling, to prevent excessive fuel supplementation.

Further, a side face of the upper cover is provided with a vent hole, a side, connected to the connecting member, of the upper cover is provided with an annular flange outer ring portion, an annular flange inner ring portion and an avoidance step surface sequentially from outside to inside, and heights of the flange outer ring portion, the flange inner ring portion and the avoidance step surface decrease sequentially from outside to inside, that is, the height of the flange outer ring portion>the height of the flange inner ring portion>the height of the avoidance step surface; the flange outer ring portion is welded to the high-pressure fuel tank, an end face of the flange inner ring portion abuts against a flange edge of the connecting member for axial limiting between the upper cover and the connecting member, and the avoidance step surface fits with an end face of a retaining ring of the connecting member, and the avoidance step surface is directly opposite to an end face of the retaining ring.

Further, the connecting member includes an upper cylindrical portion and a lower cylindrical portion that are arranged one above another, a partition plate is arranged between the upper cylindrical portion and the lower cylindrical portion, the flange edge is formed at an outside of the connecting member, and the upper cylindrical portion and the upper cover covering the upper cylindrical portion jointly form a liquid collector, the liquid collector controls static and dynamic spillage of a liquid in the high-pressure fuel tank, and the liquid can flow back into the fuel tank; a cavity inside the liquid collector is a liquid collecting cavity, a cavity inside the lower cylindrical portion is a connecting cavity, the liquid collecting cavity is internally provided with an upwardly protruding cap-like structure, the cap-like structure has a lateral opening in communication with a liquid return port formed in the partition plate, and the liquid return port is in communication with the liquid collecting cavity and the connecting cavity; a side of the partition plate opposite to the liquid return port is raised upwardly to form a refueling boss, a refueling valve seat is arranged on the refueling boss, an annular positioning sleeve is arranged above the refueling valve seat, an inner wall of the positioning sleeve is uniformly provided with a plurality of cylindrical surface grooves in a circumferential direction, the refueling control valve assembly is arranged in the positioning sleeve, the refueling valve seat below the refueling control valve assembly is provided with a refueling air hole, and a lower end of the refueling air hole is in communication with the second accommodating cavity; an upper end of the refueling air hole is in a shape of a circular hole, a lower end of the refueling air hole is in a shape of a flat hole, a bottom surface of the flat hole is an inclined ramp, and the inclined ramp fits with the gradient exhaust assembly in angle.

Specifically, a side wall of the upper cylindrical portion is composed of two cylindrical segments with different inner diameters, which are respectively a first cylindrical surface and a second cylindrical surface, and the radius of the first cylindrical surface is greater than the radius of the second cylindrical surface, and the first cylindrical surface is located on a side of the upper cylindrical portion away from the refueling boss; an annular retaining ring is arranged on the flange edge on an outer side of the upper cylindrical portion, and a sinking groove is arranged between an outer side of the first cylindrical surface and the retaining ring. An occupied space is reduced by using an irregular shape.

Further, the bottom of the second accommodating cavity is provided with first low-level liquid discharging holes, an exhaust cavity is formed between an outer wall of the second accommodating cavity and a side wall of the lower housing, a bottom of the exhaust cavity is provided with second low-level liquid discharging holes, at least one high-position exhaust hole is formed in a portion of the connecting member combined with the lower housing, and the high-position exhaust hole is in communication with the exhaust cavity.

A valve body composed of the upper cover, the connecting member and so on is connected to the high-pressure fuel tank by means of hot plate welding, and during welding, flash occurs, which is likely to clog the high-position exhaust holes on a side face of the connecting member. Therefore, in order to avoid the clogging of the high-position exhaust holes, further, a side wall of the lower cylindrical portion is provided with a plurality of outer protrusion portions protruding outwardly, an inner recess portion is formed between adjacent outer protrusion portions and the inner recess portion are alternate with each other, and at least one of the outer protrusion portions is provided with a high-position exhaust hole; the high-position exhaust hole includes a first high-position exhaust hole and a second high-position exhaust hole, the outer protrusion portion at the first high-position exhaust hole is recessed inwardly to form an avoidance groove, and the second high-position exhaust hole is formed on the outer protrusion portion below the avoidance groove; a snap block extending radially is arranged on an outer side of the inner recess portion. An avoidance design is adopted at the high-position exhaust hole, so that the risk of hot plate welding quality of the valve body and the high-pressure fuel tank is reduced; meanwhile, by using a positioning structure in which the protrusion portions fit with the recess portions, stable and reliable connection between different components of the valve body can be achieved.

Further, a edge of an upper portion of the lower housing is provided with baffle plates, a U-shaped groove for embedding the outer protrusion portion is formed between adjacent baffle plates, and the baffle plate is provided with a snap hole fitting with the snap block; during assembly, the outer protrusion portions are embedded into the U-shaped grooves, and the snap blocks are inserted into the snap holes to implement the fixed connection and limiting between the connecting member and the lower housing.

Further, the refueling control valve assembly has a maximum flow rate greater than 350 LPM, and the gradient exhaust assembly has a maximum flow rate greater than 80 LPM.

Further, the fueling control valve assembly includes a fueling first-order float, a fueling second-order float, a nylon framework and a first spring; the fueling first-order float includes an inner cylinder and an outer cylinder, and upper ends of the inner cylinder and the outer cylinder are connected by means of radial connecting rods to ensure internal and external synchronous upward/downward float; the first spring is arranged between the inner cylinder and the outer cylinder, an upper end of the first spring abuts against an inner wall of the outer cylinder, and a lower end of the first spring abuts against the lower housing; the fueling second-order float is arranged at an upper end of the nylon framework, and a lower end of the nylon framework is inserted in the upper end of the inner cylinder and the upper end of the outer cylinder, the nylon framework is located between the inner cylinder and the outer cylinder and is able to float up and down relative to the fueling first-order float in an axial direction; the opening of the fueling second-order float of the fueling control valve assembly is primary opening, the opening of the fueling first-order float is secondary opening, a pressure for primary opening is 35 kPa or above, and a pressure for secondary opening is 2 kPa or above

Further, the gradient exhaust assembly includes an exhaust first-order float, an exhaust second-order float, a second spring and a press block, the exhaust first-order float is of a hollow cylindrical structure with an open bottom, the second spring is mounted into the exhaust first-order float from bottom to top, an upper end of the second spring abuts against the exhaust first-order float, a lower end of the second spring abuts against the bottom of the second accommodating cavity, and the second spring is elastically supported between the exhaust first-order float and the lower housing; the exhaust second-order float includes a ramp boss arranged on a top of the exhaust first-order float, a rubber pad and a press block, the rubber pad is arranged on the ramp boss, an end, located on a top of the ramp boss, of the rubber pad is fixed to the ramp boss by means of the press block, and an other end of the rubber pad is laid down along the ramp boss to a bottom of the ramp boss; at least one structural hole is formed in a side wall of the exhaust first-order float, and is configured to communicate between an inside and an outside of the exhaust first-order float; the opening of the exhaust second-order float of the gradient exhaust assembly is primary opening, the opening of the exhaust first-order float is secondary opening, a pressure for primary opening is 45 kPa or above, and a pressure for secondary opening is 10 kPa or above.

The fueling first-order float and the fueling second-order float of the fueling control valve assembly and the exhaust first-order float and the exhaust second-order float of the gradient exhaust assembly are all made of a phenolic resin material, and have excellent thermal stability and abrasion resistance.

Further, an outer wall of the exhaust first-order float is provided with a guide groove in an axial direction, and an inner wall of the second accommodating cavity is provided with a guide bar fitting with the guide groove. During assembly, the guide bar is embedded into the guide groove. Also, when the exhaust first-order float floats, the guide bar can slide up and down within the guide groove.

The present disclosure has the following beneficial effects:
(1) Within a diameter range of 81.5 mm, the functions of the fueling control valve, the refueling control valve, the gradient exhaust valve and the liquid collector are integrated, the floats in irregular shapes are used for the first time to decrease the overall diameter of the valve.
(2) A new material (phenolic resin) is applied to the floats, and compared to a conventional POM or nylon material, the thermal stability, the abrasion resistance and the dimensional stability of the floats are greatly improved.
(3) When the hybrid electric vehicle is driven in a pure electric mode, due to the absence of engine noise, the requirement for quietness inside a cabin is higher; when the vehicle is running, especially on bumpy road sections, the floats in the valve body float up and down to produce bumping sound. The present disclosure uses a design of float noise reduction and is further provided with the rubber shock-absorbing pad, so that the noise in decibel is reduced by 60%, the low noise requirement during driving in the pure electric mode is met, and the actually measured noise of the float is reduced from 70 decibels to 40 decibels.
(4) By adopting the design of preventing flash clogging during hot plate welding, the risk of hot plate welding quality of the valve and the fuel tank is reduced.
(5) Both the level control valve and the gradient exhaust valve use a two-order opening design, a pressure for primary opening of the level control valve is 35 kPa or above, and a pressure for secondary opening is 2 kPa or above; with regard to the grade exhaust valve, the pressure for primary opening is 45 kPa or above, and the pressure for secondary opening is 10 kPa or above. A time for pressure relief of the high-pressure fuel tank from 30 kPa to 2 kPa is less than 5 seconds.
(6) The maximum flow of the level control valve (the fueling control valve assembly) is greater than 350 LPM, and the maximum flow of the gradient exhaust assembly is greater than 80 LPM, so that an excessively large flow during the pressure relief of the high-pressure fuel tank causes the valve to be closed, resulting in the failure of pressure relief of the high-pressure fuel tank.
(7) The special cap-like structure is designed in the liquid collector, so that the liquid is prevented from being sprayed out of the valve body instantaneously when a fuel gun is automatically shut off or the vehicle shakes vigorously.
(8) The design of the liquid collector is collected, so that dynamic leakage or static leakage is prevented, and the liquid can flow back into the fuel tank.

### BRIEF DESCRIPTION OF THE DRAWINGS

The present disclosure will be further described below with reference to the accompanying drawings and embodiments.

FIG. 1 shows a structural perspective schematic diagram of a multifunctional valve dedicated for a high-pressure fuel tank of a hybrid electric vehicle according to one or more embodiments of the invention;

FIG. 2 shows a structural perspective schematic diagram of the multifunctional valve dedicated for the high-pressure fuel tank of the hybrid electric vehicle according to one or more embodiments of the invention;

FIG. 3 shows a side structural schematic diagram of the multifunctional valve dedicated for the high-pressure fuel tank of the hybrid electric vehicle according to one or more embodiments of the invention;

FIG. 4 shows a structural schematic sectional view of the multifunctional valve dedicated for the high-pressure fuel tank of the hybrid electric vehicle according to one or more embodiments of the invention;

FIG. 5 shows a structural perspective schematic diagram of an upper cover of the multifunctional valve dedicated for the high-pressure fuel tank of the hybrid electric vehicle according to one or more embodiments of the invention;

FIG. 6 shows a structural schematic sectional view of the upper cover of the multifunctional valve dedicated for the high-pressure fuel tank of the hybrid electric vehicle according to one or more embodiments of the invention;

FIG. 7 shows a structural schematic diagram (in a forward direction) of a connecting member of the multifunctional valve dedicated for the high-pressure fuel tank of the hybrid electric vehicle according to one or more embodiments of the invention;

FIG. 8 shows a structural schematic diagram (in a reverse direction) of the connecting member of the multifunctional valve dedicated for the high-pressure fuel tank of the hybrid electric vehicle according to one or more embodiments of the invention;

FIG. 9 shows a structural schematic enlarged view of a positioning sleeve in FIG. 7;

FIG. 10 shows a structural perspective schematic diagram of a lower housing of the multifunctional valve dedicated for the high-pressure fuel tank of the hybrid electric vehicle according to one or more embodiments of the invention;

FIG. 11 shows a structural schematic top view of the lower housing of the multifunctional valve dedicated for the high-pressure fuel tank of the hybrid electric vehicle according to one or more embodiments of the invention;

FIG. 12 shows a structural schematic diagram illustrating that the lower housing is assembled with a fueling control valve assembly and a gradient exhaust assembly in the multifunctional valve dedicated for the high-pressure fuel tank of the hybrid electric vehicle according to one or more embodiments of the invention;

FIG. 13 shows a structural perspective schematic diagram of the fueling control valve assembly of the multifunctional valve dedicated for the high-pressure fuel tank of the hybrid electric vehicle according to one or more embodiments of the invention;

FIG. 14 shows a structural schematic sectional view (showing a lower housing) of the fueling control valve assembly of the multifunctional valve dedicated for the high-pressure fuel tank of the hybrid electric vehicle according to one or more embodiments of the invention;

FIG. 15 shows a structural perspective schematic diagram of the gradient exhaust assembly of the multifunctional valve dedicated for the high-pressure fuel tank of the hybrid electric vehicle according to one or more embodiments of the invention;

FIG. 16 shows a structural perspective schematic diagram of the gradient exhaust assembly of the multifunctional valve dedicated for the high-pressure fuel tank of the hybrid electric vehicle according to one or more embodiments of the invention;

FIG. 17 is a structural schematic sectional view of the gradient exhaust assembly of the multifunctional valve dedicated for the high-pressure fuel tank of the hybrid electric vehicle according to one or more embodiments of the invention;

In the figures: 1. Upper cover; 1.1. Vent opening; 1.2. Flange outer ring portion; 1.3. Flange inner ring portion; 1.4. Avoidance step surface; 2. Connecting member; 2.1. Upper cylindrical portion; 2.2. Cap-like structure; 2.3. First high-position exhaust hole; 2.4. Avoidance groove; 2.5. Second high-position exhaust hole; 2.6. Refueling boss; 2.7. Refueling valve seat; 2.8. Positioning sleeve; 2.9. Cylindrical surface groove; 2.10. Refueling air hole; 2.11. Breathing hole; 2.12. Snap block; 2.13. Outer protrusion portion; 2.14. Inner recess portion; 2.15. Flange edge; 2.16. Sinking groove; 2.17. Retaining ring; 2.18. Lower cylindrical portion; 3. Lower housing; 3.1. U-shaped groove; 3.2. Baffle plate; 3.3. Snap hole; 3.4. First low-level liquid discharging hole; 3.5. Volume control window; 3.6. Second low-level liquid discharging hole; 3.7. First accommodating cavity; 3.8. Second accommodating cavity; 3.9. Exhaust cavity; 3.10. Guide bar; 4. Fueling control valve assembly; 4.1. Fueling first-order float; 4.1a. Inner cylinder; 4.1b. Outer cylinder; 4.2. First spring; 4.3. Fueling second-order float; 4.4 Nylon framework; 4.5. Exhaust hole; 5. Refueling control valve assembly; 6. Gradient exhaust assembly; 6.1. Exhaust first-order float; 6.2. Ramp boss; 6.3. Guide groove; 6.4. Rubber pad; 6.5. Second spring; 6.6. Press block; 6.7. Structural hole; 7. Shock-absorbing pad.

### DETAILED DESCRIPTION OF THE EMBODIMENTS

The present disclosure will be further described in detail with reference to the accompanying drawings. These drawings are simplified schematic diagrams illustrating only a basic structure of the present disclosure in a schematic manner. Therefore, these drawings only show the composition, direction and references relevant to the present disclosure (e.g. up, bottom, left, and right), which may only be used to assist the description of the features in the drawings. Therefore, instead of using the following specific implementations in a limiting sense, the scope of the claimed subject matter is defined only by the appended claims and their equivalents.

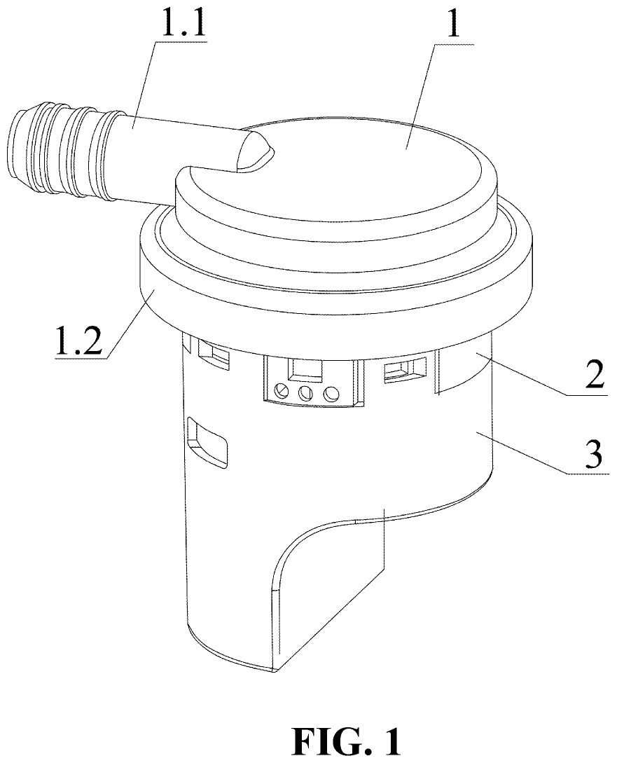

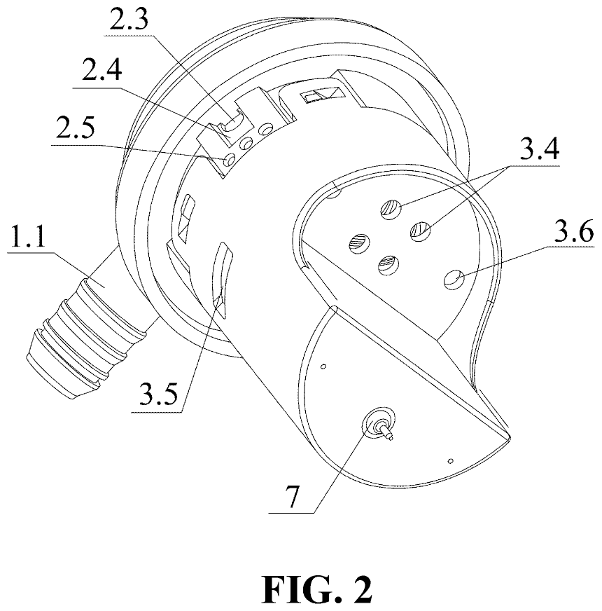

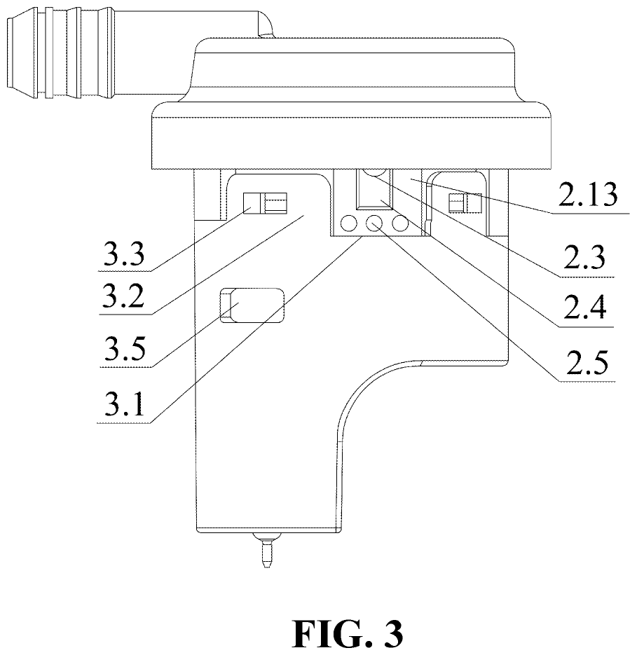

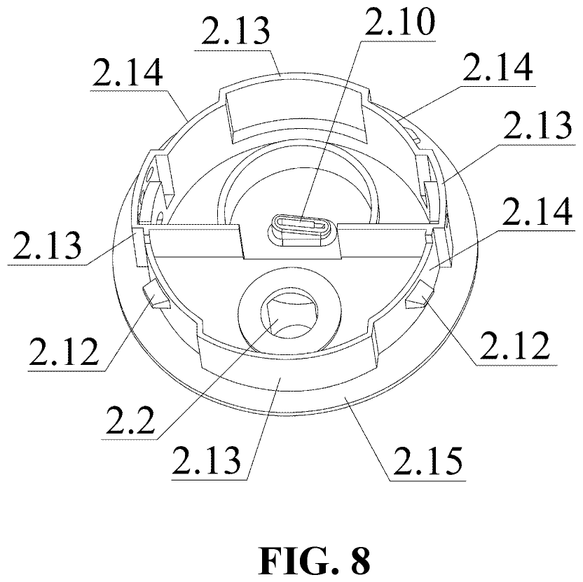

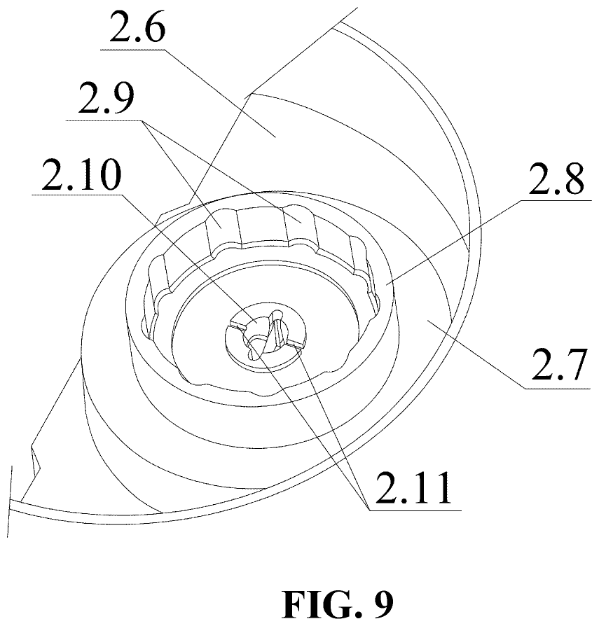

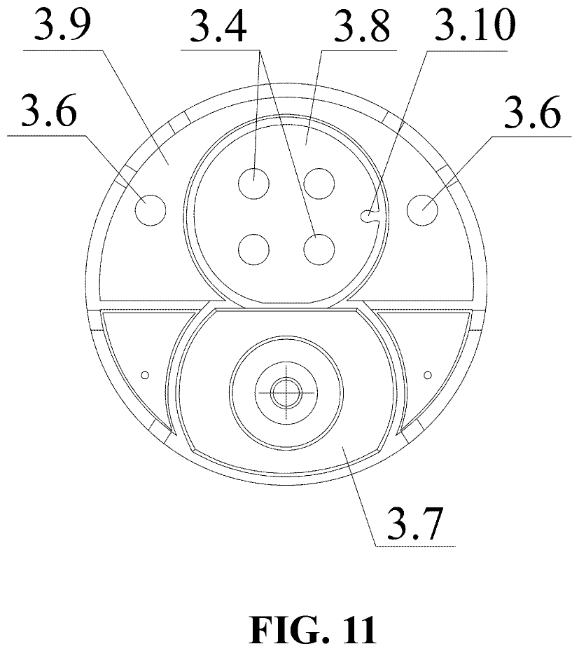

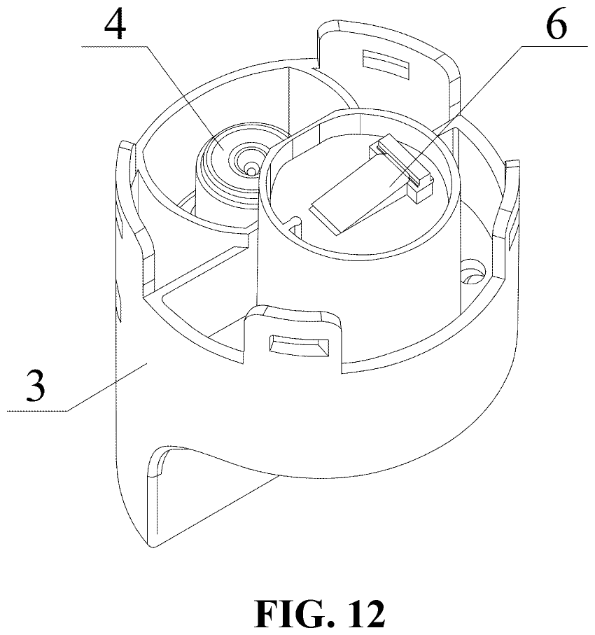

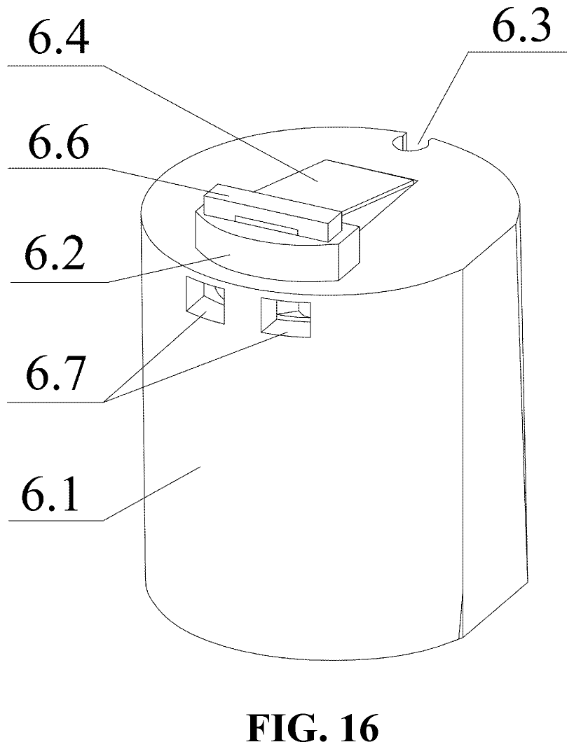

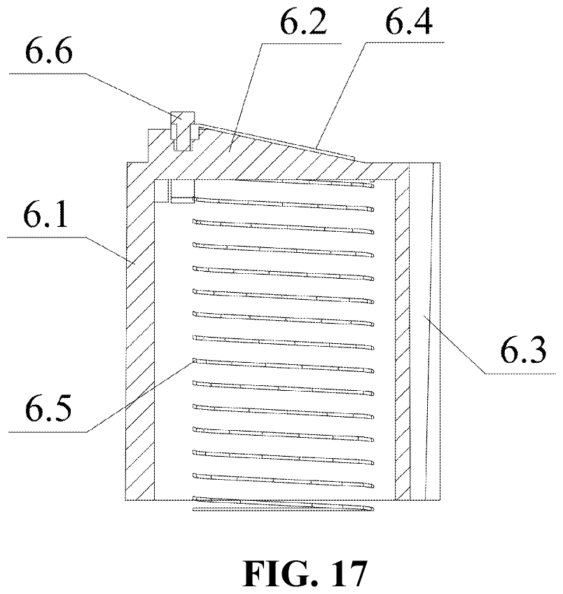

As shown in FIGS. 1-17, a multifunctional valve dedicated for a high-pressure fuel tank of a hybrid electric vehicle of the present disclosure includes: an upper cover 1 securely connected to the high-pressure fuel tank, and is provided with a vent opening 1.1 at a portion of the upper cover located on an outer side of the high-pressure fuel tank; a lower housing 3 located inside the high-pressure fuel tank and has a first accommodating cavity 3.7 and a second accommodating cavity 3.8, a bottom of the second accommodating cavity 3.8 being higher than a bottom of the first accommodating cavity 3.7; a connecting member 2 with an upper end connected to the upper cover 1 and a lower end connected to the lower housing 3, and the connecting member serving as an intermediate member to be connected between the upper cover 1 and the lower housing 3; as shown in FIG. 12, a fueling control valve assembly 4 arranged in the first accommodating cavity 3.7 of the lower housing 3 and can float up and down within the first accommodating cavity 3.7 to control a fueling amount; where a shock-absorbing pad is arranged at the bottom of the first accommodating cavity 3.7; a gradient exhaust assembly 6 arranged in the second accommodating cavity 3.8 of the lower housing 3 and can float up and down within the second accommodating cavity 3.8 to implement exhausting; and a refueling control valve assembly 5 arranged on the connecting member 2 above the gradient exhaust assembly 6 and is used for controlling an amount of supplemented fuel during refueling. The maximum flow of the fueling control valve assembly 4 is greater than 350 LPM, that is, the fueling control valve assembly 4 is not closed when a flow does not exceed 350 LPM; the maximum flow of the gradient exhaust assembly 6 is greater than 80 LPM, that is, the gradient exhaust assembly 6 is not closed when the flow does not exceed 80 LPM. A phenomenon is prevented that the flow is excessively large during high pressure relief of the high-pressure fuel tank to cause the closing of the valve, resulting in the failure of pressure relief of the high-pressure fuel tank.

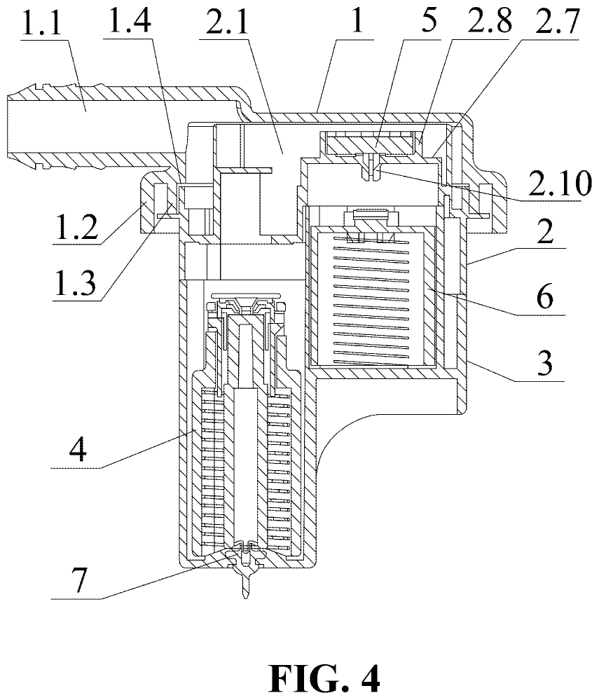

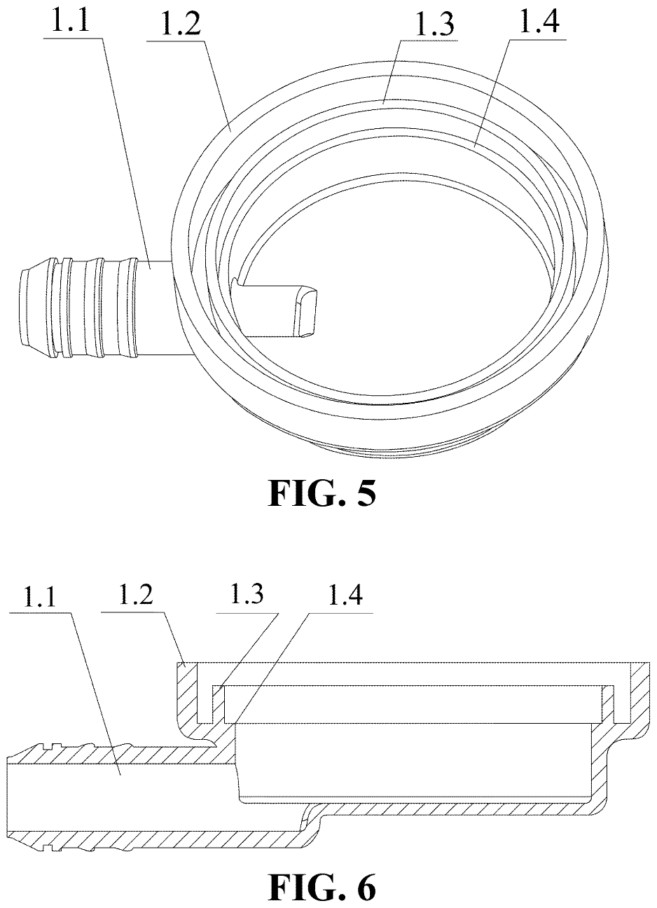

As shown in FIGS. 5 and 6, a side face of the upper cover 1 is provided with the vent opening 1.1, a side, connected to the connecting member 2, of the upper cover 1 is provided with an annular flange outer ring portion 1.2, an annular flange inner ring portion 1.3 and an avoidance step surface 1.4 sequentially from outside to inside, and heights thereof decrease sequentially from outside to inside, that is, the height of the flange outer ring portion 1.2>the height of the flange inner ring portion 1.3>the height of the avoidance step surface 1.4; as shown in FIG. 4, the flange outer ring portion 1.2 is welded to the high-pressure fuel tank, an end face of the flange inner ring portion 1.3 abuts against a flange edge 2.15 of the connecting member 2 for axial limiting between the upper cover 1 and the connecting member 2, the avoidance step surface 1.4 fits with an end face of a retaining ring 2.17 of the connecting member 2, and the avoidance step surface 1.4 is directly opposite to an end face of the retaining ring 2.17.

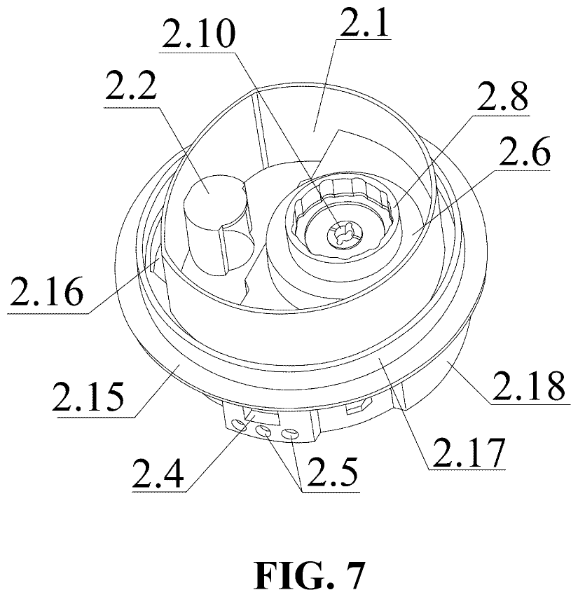

As shown in FIGS. 7-9, the connecting member 2 includes an upper cylindrical portion 2.1 and a lower cylindrical portion 2.18 that are arranged one above another, a partition plate is arranged between the upper cylindrical portion 2.1 and the lower cylindrical portion 2.18, and the flange edge is 2.15 formed at an outside of the connecting member. The upper cylindrical portion 2.1 and the upper cover 1 covering the upper cylindrical portion jointly form a liquid collector, a cavity inside the liquid collector is a liquid collecting cavity, a cavity inside the lower cylindrical portion 2.18 is a connecting cavity, the liquid collecting cavity is internally provided with an upwardly protruding cap-like structure 2.2, the cap-like structure 2.2 has a lateral opening in communication with a liquid return port formed in the partition plate, and the liquid return port is in communication with the liquid collecting cavity and the connecting cavity; a side of the partition plate opposite to the liquid return port is raised upwardly to form a refueling boss 2.6, a refueling valve seat 2.7 is arranged on the refueling boss 2.6, an annular positioning sleeve 2.8 is arranged above the refueling valve seat 2.7, an inner wall of the positioning sleeve 2.8 is uniformly provided with multiple cylindrical surface grooves 2.9 in a circumferential direction to form a gas flow passage between the positioning sleeve 2.8 and the refueling control valve assembly 5, and when the refueling control valve assembly 5 is closed, the gas flow passage acts as a gas exhaust passage to exhaust a gas along the cylindrical surface grooves 2.9 of the inner wall; the refueling control valve assembly 5 is arranged in the positioning sleeve 2.8, the refueling valve seat 2.7 below the refueling control valve assembly 5 is provided with a refueling air hole 2.10, and a lower end of the refueling air hole 2.10 is in communication with the second accommodating cavity 3.8; the refueling air hole 2.10 has an upper end in the shape of a circular hole and a lower end in the shape of a flat hole, where a bottom surface of the flat hole is an inclined ramp, and the inclined ramp fits with a ramp boss of the gradient exhaust assembly 6 in angle; the refueling air hole 2.10 serves as a venting and sealing hole of the gradient exhaust assembly, and the flat hole of the lower end is used for fitting with an elongated sealing gasket, namely, a rubber gasket 6.4, so the design enables the reopening performance to be better. The refueling valve seat 2.7 at the circular hole-like end of the refueling air hole 10 is provided with two symmetrical breathing holes 2.11 in a radial direction, the refueling air hole is in communication with the liquid collecting cavity through the breathing holes 2.11 and the cylindrical surface grooves 2.9 on the inner wall, and the elongated breathing holes 2.11 are the breathing holes for the fuel tank exhausting air to the outside when the refueling control valve assembly 5 is closed. Specifically, a side wall of the upper cylindrical portion 2.1 is composed of two cylindrical segments with different inner diameters, which are respectively a first cylindrical surface and a second cylindrical surface, and the radius of the first cylindrical surface is greater than the radius of the second cylindrical surface, and the first cylindrical surface is located on a side of the upper cylindrical portion 2.1 away from the refueling boss 2.6; an annular retaining ring 2.17 is arranged on the flange edge 2.15 on an outer side of the upper cylindrical portion 2.1, and a sinking groove 2.16 is arranged between an outer side of the first cylindrical surface and the retaining ring 2.17. An occupied space is reduced by using an irregular shape. A side wall of the lower cylindrical portion 2.18 is provided with multiple outer protrusion portions 2.13 protruding outwardly, an inner recess portion 2.14 is formed between adjacent outer protrusion portions 2.13, the outer protrusion portions 2.13 and the inner recess portion 2.14 are alternate with each other, and at least one of the outer protrusion portions 2.13 is provided with a high-position exhaust hole; the high-position exhaust hole includes a first high-position exhaust hole 2.3 and a second high-position exhaust hole 2.5, the outer protrusion portion 2.13 at the first high-position exhaust hole 2.3 is recessed inwardly to form an avoidance groove 2.4, and the second high-position exhaust hole 2.5 is formed on the outer protrusion portion 2.13 below the avoidance groove 2.4; snap blocks 2.12 extending radially are arranged on an outer side of the inner recess portion 2.14. In this embodiment, the number of the outer protrusion portions 2.13 and the number of the inner recess portions 2.14 are each four, and these portions are distributed uniformly in the circumferential direction, where the two radially opposite outer protrusion portions 2.13 are provided with the first high-position exhaust hole 2.3, the second high-position exhaust holes 2.5 and the avoidance grooves 2.4, and the other two outer protrusion portions 2.13 are provided with no exhaust holes; one first high-position exhaust hole 2.3 is provided and located at an upper part of the outer protrusion portion 2.13, and has a larger diameter, three second high-position exhaust holes 2.5 are provided and located at lower parts of the outer protrusion portions 2.13, are arranged side by side, and have a smaller hole diameter.

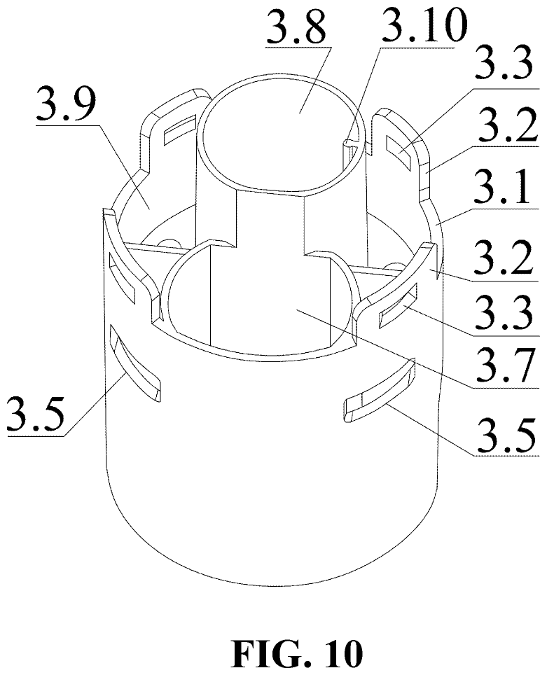

As shown in FIGS. 10-12, a edge of an upper portion of the lower housing 3 is provided with baffle plates 3.2, a U-shaped groove 3.1 for embedding an outer protrusion portion 2.13 is formed between adjacent baffle plates 3.2, and each baffle plate 3.2 is provided with a snap hole 3.3 fitting with the snap block 2.12; during assembly, the outer protrusion portions 2.13 are embedded into the U-shaped grooves 3.1, and the snap blocks 2.12 are inserted into the snap holes 3.3 to implement the fixed connection and limiting between the connecting member 2 and the lower housing 3. The bottom of the second accommodating cavity 3.8 is provided with first low-level liquid discharging holes 3.4, an exhaust cavity 3.9 is formed between an outer wall of the second accommodating cavity 3.8 and a side wall of the lower housing 3, a bottom of the exhaust cavity 3.9 is provided with second low-level liquid discharging holes 3.6, and the first high-position exhaust hole 2.3 and the second high-position exhaust holes 2.5 are in communication with the exhaust cavity 3.9. The side wall of the lower housing 3 is further provided with two volume control windows 3.5 and used for volume control of the fueling control valve assembly 4.

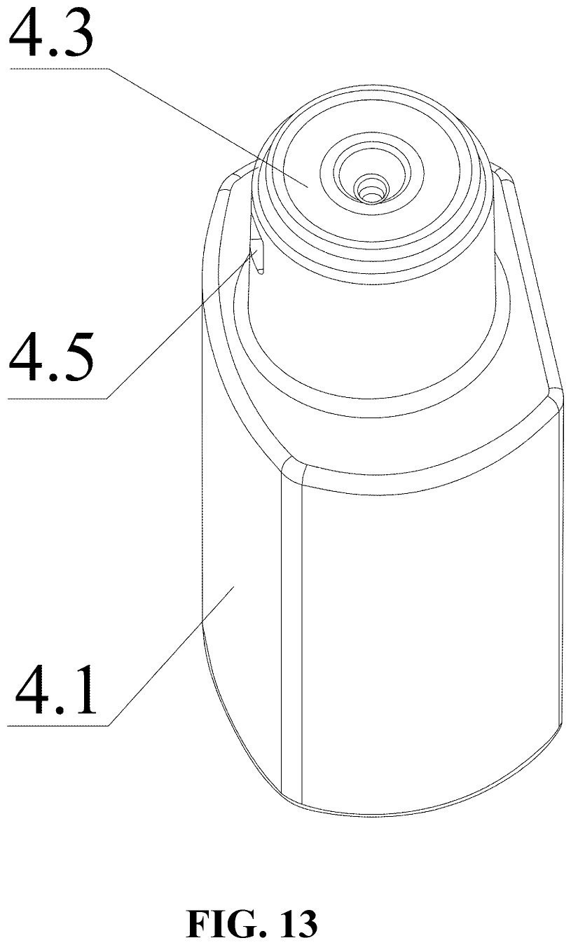

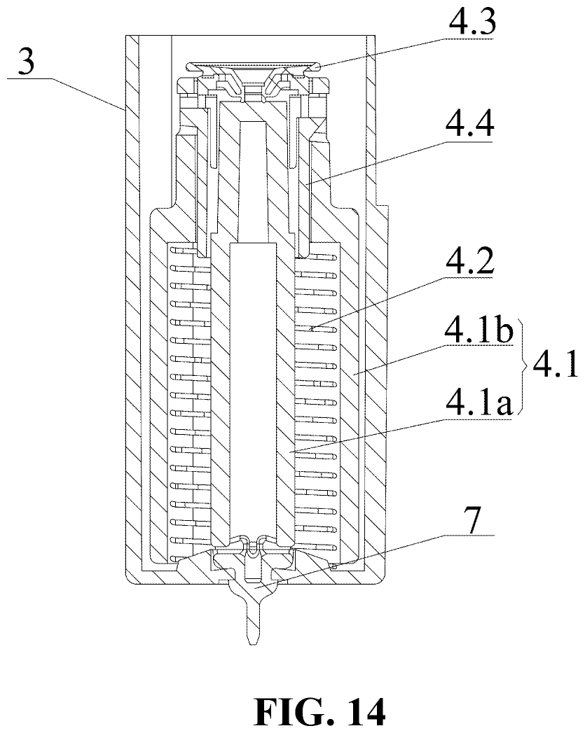

As shown in FIGS. 13 and 14, the fueling control valve assembly 4 includes a fueling first-order float 4.1, a fueling second-order float 4.3, a nylon framework 4.4 and a first spring 4.2; the fueling first-order float 4.1 is configured with an irregular shape to reduce an overall diameter of the valve, and includes an inner cylinder 4.1a and an outer cylinder 4.1b; upper ends of the inner cylinder 4.1a and the outer cylinder 4.1b are connected by means of radial connecting rods to ensure internal and external synchronous upward/downward float, a bottom of the inner cylinder 4.1a is located directly above the shock-absorbing pad, avoiding that the fueling first-order float 4.1 directly bumps against the first accommodating cavity 3.7 of the lower housing 3 when being lowered to its lowest position, reducing noise; the first spring 4.2 is arranged between the inner cylinder 4.1a and the outer cylinder 4.1b, an upper end of the first spring abuts against an inner wall of the outer cylinder 4.1b, and a lower end of the first spring abuts against the lower housing 3; the fueling second-order float 4.3 is arranged at an upper end of the nylon framework 4.4, and the lower end of the nylon framework 4.4 is inserted in the upper end of the inner cylinder 4.1a and the upper end of the outer cylinder 4.1b the nylon framework 4.4 is located between the inner cylinder 4.1a and the outer cylinder 4.1b, and can float up and down relative to the fueling first-order float 4.1 in the axial direction; with regard to the fueling control valve assembly 4, a pressure for primary opening (i.e. the opening of the fueling second-order float 4.1) is 35 kPa or above, and a pressure for secondary opening (i.e. the opening of the fueling first-order float 4.3) is 2 kPa or above.

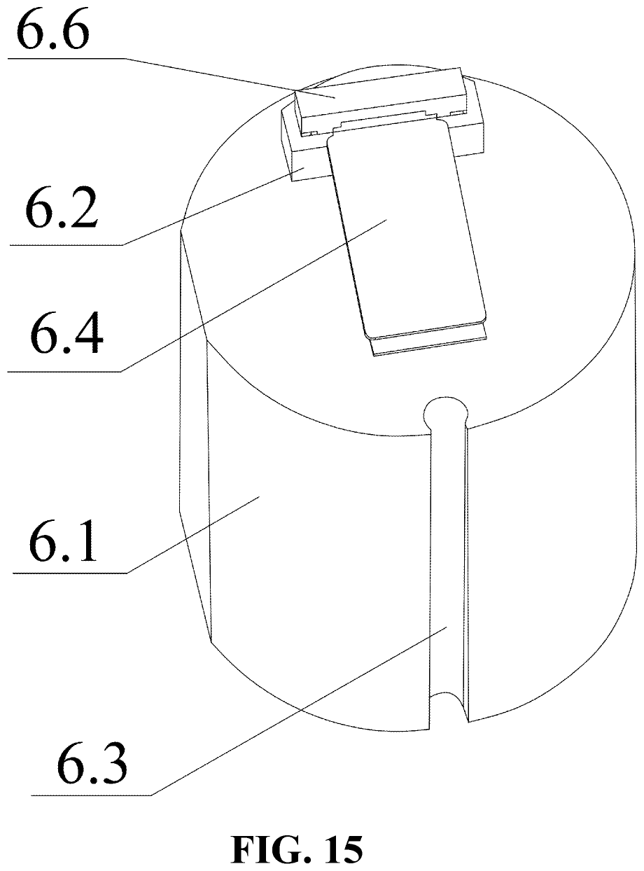

As shown in FIGS. 15-17, the gradient exhaust assembly 6 includes an exhaust first-order float 6.1, an exhaust second-order float, a second spring 6.5 and a press block 6.6, the exhaust first-order float 6.1 is of a hollow cylindrical structure and is open at its bottom, the second spring 6.5 is mounted into the exhaust first-order float 6.1 from bottom to top, an upper end of the second spring 6.5 abuts against the exhaust first-order float 6.1, a lower end of the second spring abuts against the bottom of the second accommodating cavity 3.8, and the second spring 6.5 is elastically supported between the exhaust first-order float 6.1 and the lower housing 3; the exhaust second-order float includes a ramp boss 6.2 arranged on a top of the exhaust first-order float 6.1, a rubber pad 6.4 and a press block 6.6, the rubber pad 6.4 is arranged on the ramp boss 6.2, an end, located on a top of the ramp boss 6.2, of the rubber pad 6.4 is fixed to the ramp boss 6.2 by means of the press block 6.6, and an other end of the rubber pad is laid down along the ramp boss 6.2 to a bottom of the ramp boss 6.2; at least one structural hole 6.7 is formed in a side wall of the exhaust first-order float 6.1, and is configured to communicate between an inside and an outside of the exhaust first-order float 6.1, and two structural holes 6.7 are provided in this embodiment; with regard to the grade exhaust assembly 6, a pressure for primary opening (i.e. the opening of the exhaust second-order float) is above 45 kPa or above, and a pressure for secondary opening (i.e. the opening of the exhaust first-order float 6.1) is 10 kPa or above. An outer wall of the exhaust first-order float 6.1 is provided with a guide groove 6.3 in the axial direction, and an inner wall of the second accommodating cavity 3.8 is provided with a guide bar 3.10 fitting with the guide groove 6.3. During assembly, the guide bar 3.10 is embedded into the guide groove 6.3. Also, when the exhaust first-order float 6.1 floats, the guide bar 3.10 can slide up and down in the guide groove 6.3.

In this embodiment, the fueling first-order float 4.1 and the fueling second-order float 4.3 of the fueling control valve assembly 4 and the exhaust first-order float 6.1 and the exhaust second-order float of the gradient exhaust assembly 6 are all made of a phenolic resin material, and have excellent thermal stability and abrasion resistance. Phenolic resin is a thermosetting material, the dimensional tolerance of mass production and molding can reach ±0.02, while the tolerance of ordinary materials such as POM and nylon is only ±0.2. The higher the dimensional stability, the better the reliability of upward/downward floating of the floats. Moreover, the phenolic resin are better than the POM and the nylon in terms of abrasion resistance and high and low temperature resistance. The phenolic resin material has a specific gravity two times greater than the specific gravity of the POM or the nylon, which is prone to achieving small size and large weight.

The operating principle of the fueling control valve assembly 4 is as follows:

At a high pressure, the fueling first-order float 4.1 and the fueling second-order float 4.3 are stressed to float upward to abut against a return port of the partition plate, and a return port of the liquid collector is closed; when the pressure drops to 35 kPa, the fueling first-order float 4.1 descends, so that the exhaust hole 4.5 in a middle of the fueling second-order float 4.3 is opened for exhausting, and the exhausting continues; when the pressure further drops to 2 kPa, the fueling second-order float 4.3 descends, the return port at a bottom of the liquid collector is opened to allow the communication between an interior of the fuel tank and the vent opening 1.1 by means of the liquid collector, and the oil vapor from the fuel tank is delivered to a carbon canister through the vent opening 1.1, filtered by the carbon canister and then released to the outside. During operation, when fuel is filled to reach the rated volume of the fuel tank, and the sum of a liquid buoyancy and an elastic force of the first spring 4.2 is greater than the gravity of the float, the first spring 4.2 moves upward to block the exhaust hole 4.5, resulting automatic shut-off of an oil gun and ending the fueling.

The operating principle of the gradient exhaust assembly 6 is as follows:

At a high pressure, when the exhaust first-order float 6.1 and the exhaust second-order float are stressed to float upward to allow the close fitting between the rubber pad 6.4 of the exhaust second-order float and an inclined slope surface of the flat hole at a bottom of the refueling air hole 2.10, and the refueling air hole 2.10 is closed; when the pressure drops to 45 kPa, the exhaust first-order float 6.1 descends, pulling the exhaust second-order float (i.e. the rubber pad 6.4) to deform, initially forming a small opening for exhausting; the pressure is further reduced, since the bottom of the refueling air hole 2.10 is the inclined slope surface, the exhaust second-order float is gradually pulled downward during the pressure reduction, and when the refueling air hole 2.10 is gradually opened until the pressure drops to 10 kPa, the entire refueling air hole 2.10 is opened for exhausting. In operation, when gasoline in the fuel tank is sloshed into a valve cavity, the second spring 6.5 moves upward, allowing the float of the gradient exhaust assembly to block the fueling air hole 2.10 above the float, so that the gasoline liquid is prevented from entering the exhaust hole and flowing into the carbon canister.

During refueling, the refueling control valve assembly 5 is not opened, a flow is limited to control an amount of supplemented fuel.

The above descriptions are on the basis of ideal embodiments of the present disclosure as enlightenment, and with the above descriptions, relevant staff can make various changes and modifications without deviating from the scope of the present disclosure. The technical scope of the present disclosure is not limited to what is stated in the Description, and must be determined according to the scope of the claims.

What is claimed is:

1. A multifunctional valve dedicated for a high-pressure fuel tank of a hybrid electric vehicle, comprising:
an upper cover securely connected to a high-pressure fuel tank, and provided with a vent opening at a portion of the upper cover located on an outer side of the high-pressure fuel tank;
a lower housing located inside the high-pressure fuel tank and comprising a first accommodating cavity and a second accommodating cavity, wherein a bottom of the second accommodating cavity is higher than a bottom of the first accommodating cavity;
a connecting member with an upper end connected to the upper cover and a lower end connected to the lower housing, the connecting member serving as an intermediate member to be connected between the upper cover and the lower housing;
a fueling control valve assembly arranged in the first accommodating cavity of the lower housing, and being able to float up and down within the first accommodating cavity to control a fueling amount;
a shock-absorbing pad being arranged at the bottom of the first accommodating cavity;
a gradient exhaust assembly arranged in the second accommodating cavity of the lower housing, and being able to float up and down within the second accommodating cavity to achieve exhaust; and
a refueling control valve assembly arranged on the connecting member above the gradient exhaust assembly, and is configured to control an amount of supplemented fuel during refueling.

2. The multifunctional valve dedicated for the high-pressure fuel tank of the hybrid electric vehicle as claimed in claim 1, wherein
a side face of the upper cover is provided with a vent hole,
a side, connected to the connecting member, of the upper cover is provided with an annular flange outer ring portion, an annular flange inner ring portion and an avoidance step surface sequentially from outside to inside,
heights of the annular flange outer ring portion, the annular flange inner ring portion and the avoidance step surface decrease sequentially from outside to inside,
the annular flange outer ring portion is welded to the high-pressure fuel tank,
an end face of the annular flange inner ring portion abuts against a flange edge of the connecting member for axial limiting between the upper cover and the connecting member, and
the avoidance step surface fits with an end face of a retaining ring of the connecting member.

3. The multifunctional valve dedicated for the high-pressure fuel tank of the hybrid electric vehicle as claimed in claim 1, wherein
the connecting member comprises an upper cylindrical portion and a lower cylindrical portion that are arranged one above another,
a partition plate is arranged between the upper cylindrical portion and the lower cylindrical portion,
a flange edge is formed at an outside of the connecting member,
the upper cylindrical portion and the upper cover covering the upper cylindrical portion jointly form a liquid collector,
a cavity inside the liquid collector is a liquid collecting cavity,
a cavity inside the lower cylindrical portion is a connecting cavity,
the liquid collecting cavity is internally provided with an upwardly protruding cap-like structure,
the upwardly protruding cap-like structure comprises a lateral opening in communication with a liquid return port formed in the partition plate, and the liquid return port is in communication with the liquid collecting cavity and the connecting cavity,
a side of the partition plate opposite to the liquid return port is raised upwardly to form a refueling boss,
a refueling valve seat is arranged on the refueling boss,
an annular positioning sleeve is arranged above the refueling valve seat,
an inner wall of the annular positioning sleeve is uniformly provided with a plurality of cylindrical surface grooves in a circumferential direction,
the refueling control valve assembly is arranged in the annular positioning sleeve,
the refueling valve seat below the refueling control valve assembly is provided with a refueling air hole, and a lower end of the refueling air hole is in communication with the second accommodating cavity,
an upper end of the refueling air hole is in a shape of a circular hole,
a lower end of the refueling air hole is in a shape of a flat hole,
a bottom surface of the flat hole is an inclined ramp, and
the inclined ramp fits with the gradient exhaust assembly in angle.

4. The multifunctional valve dedicated for the high-pressure fuel tank of the hybrid electric vehicle as claimed in claim 3, wherein
the bottom of the second accommodating cavity is provided with first low-level liquid discharging holes,
an exhaust cavity is formed between an outer wall of the second accommodating cavity and a side wall of the lower housing,
a bottom of the exhaust cavity is provided with second low-level liquid discharging holes,
at least one high-position exhaust hole is formed in a portion of the connecting member combined with the lower housing, and
the at least one high-position exhaust hole is in communication with the exhaust cavity.

5. The multifunctional valve dedicated for the high-pressure fuel tank of the hybrid electric vehicle as claimed in claim 4, wherein
a side wall of the lower cylindrical portion is provided with a plurality of outer protrusion portions protruding outwardly,
an inner recess portion is formed between adjacent outer protrusion portions,
at least one of the adjacent outer protrusion portions is provided with a high-position exhaust hole,
the high-position exhaust hole comprises a first high-position exhaust hole and a second high-position exhaust hole,
an outer protrusion portion of the adjacent outer protrusion portions at the first high-position exhaust hole is recessed inwardly to form an avoidance groove,
the second high-position exhaust hole is formed on the outer protrusion portion below the avoidance groove, and
a snap block extending radially is arranged on an outer side of the inner recess portion.

6. The multifunctional valve dedicated for the high-pressure fuel tank of the hybrid electric vehicle as claimed in claim 5, wherein a edge of an upper portion of the lower housing is provided with baffle plates, a U-shaped groove that embeds the outer protrusion portion is formed between adjacent baffle plates, and each baffle plate of the adjacent baffle plates is provided with a snap hole fitting with the snap block.

7. The multifunctional valve dedicated for the high-pressure fuel tank of the hybrid electric vehicle as claimed in claim 1, wherein the refueling control valve assembly has a maximum flow rate greater than 350 LPM, and the gradient exhaust assembly has a maximum flow rate greater than 80 LPM.

8. The multifunctional valve dedicated for the high-pressure fuel tank of the hybrid electric vehicle as claimed in claim 1, wherein
the fueling control valve assembly comprises a fueling first-order float, a fueling second-order float, a nylon framework and a first spring;
the fueling first-order float comprises an inner cylinder and an outer cylinder, and upper ends of the inner cylinder and the outer cylinder are connected by means of radial connecting rods;
the first spring is arranged between the inner cylinder and the outer cylinder, an upper end of the first spring abuts against an inner wall of the outer cylinder, and a lower end of the first spring abuts against the lower housing;
the fueling second-order float is arranged at an upper end of the nylon framework, and a lower end of the nylon framework is inserted in the upper end of the inner cylinder and the upper end of the outer cylinder, the nylon framework is located between the inner cylinder and the outer cylinder and is able to float up and down relative to the fueling first-order float in an axial direction;
an opening of the fueling second-order float of the fueling control valve assembly is a primary opening, an opening of the fueling first-order float is a secondary opening, a pressure for said primary opening is 35 kPa or above, and a pressure for said secondary opening is 2 kPa or above.

9. The multifunctional valve dedicated for the high-pressure fuel tank of the hybrid electric vehicle as claimed in claim 1, wherein
the gradient exhaust assembly comprises an exhaust first-order float, an exhaust second-order float, a second spring and a press block,
the exhaust first-order float is of a hollow cylindrical structure with an open bottom,
the second spring is mounted into the exhaust first-order float from bottom to top,
an upper end of the second spring abuts against the exhaust first-order float,
a lower end of the second spring abuts against the bottom of the second accommodating cavity, and
the second spring is elastically supported between the exhaust first-order float and the lower housing;
the exhaust second-order float comprises a ramp boss arranged on a top of the exhaust first-order float, a rubber pad and a press block,
the rubber pad is arranged on the ramp boss,
an end, located on a top of the ramp boss, of the rubber pad is fixed to the ramp boss by means of the press block, and
an other end of the rubber pad is laid down along the ramp boss to a bottom of the ramp boss;
at least one structural hole is formed in a side wall of the exhaust first-order float, and is configured to communicate between an inside and an outside of the exhaust first-order float;
an opening of the exhaust second-order float of the gradient exhaust assembly is a primary opening, an opening of the exhaust first-order float is a secondary opening, a pressure for said primary opening is 45 kPa or above, and a pressure for said secondary opening is 10 kPa or above.

10. The multifunctional valve dedicated for the high-pressure fuel tank of the hybrid electric vehicle as claimed in claim 9, wherein an outer wall of the exhaust first-order float is provided with a guide groove in an axial direction, an inner wall of the second accommodating cavity is provided with a guide bar fitting with the guide groove, and during assembly, the guide bar is embedded into the guide groove, and the guide bar is able to slide up and down within the guide groove.
